(19) United States
(12) Patent Application Publication
(10) Pub. No.: US 2007/0061749 A1
(43) Pub. Date: Mar. 15, 2007

(54) Virtual focus for contextual discovery

(75) Inventor: Jeremy de Souza, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/215,685

(22) Filed: Aug. 29, 2005

(51) Int. Cl. G06F 17/00

(52) U.S. Cl. 715/767

(57) ABSTRACT

Virtual Focus allows a user to explore elements on a screen without changing the location of the current system focus. While virtually navigating around and exploring the user interface (UI) elements on the screen, the user may change the system's input focus to the current virtual focus or return to the current system focus position. The user may also choose between navigation modes such as tree navigation and spatial navigation. Virtual focus navigation also allows the user to locate elements on the screen that may not be navigated to using just the keyboard input focus. Additionally, while using virtual focus to navigate around a screen, the state of user interface elements remains constant.

### BACKGROUND

Reading a computer screen can be difficult for many visually impaired users. In order to assist these users in navigating computer screens, many different applications and devices have been developed. Two applications that are commonly utilized by the visually impaired to navigate a computer screen are screen readers and screen magnifiers. Generally, a screen reader determines what is on the screen and communicates this information to the user through a speech synthesizer or a Braille display. A screen magnifier magnifies a portion of the screen such that the user can more easily read the magnified portion of the screen.

When a screen reader is running, a synthesized voice may describe menu items, keyboard entries, graphics and text. For example, when a user presses the space bar, the screen reader may say “space.” Similarly, when the cursor is over a menu item, the screen reader may say the command name. Users typically navigate the computer screen using keyboard shortcuts while listening to the audio generated by the screen reader. When exploring the screen to determine its content, a user may lose track of their position on the screen or may accidentally change the state of a control on the screen.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computer screen may be navigated using a virtual focus navigation mode instead of changing the system focus to navigate. While a user is virtually navigating around and exploring the user interface (UI) elements on the screen using the virtual focus navigation mode, the system's current focus is maintained while the virtual focus changes. At any time during the navigation, a user may toggle between the system's focus and the virtual focus mode. The system's current focus position may also be set to the current virtual focus position. The user may also choose between different virtual navigation modes such as tree navigation and spatial navigation.

Virtual focus navigation also allows a user to locate elements on the screen that may not be navigated to using just the system's keyboard focus. Additionally, while using virtual focus to navigate around a screen, the state of user interface elements remains constant.

### BRIEF DESCRIPTION OF THE DRAWINGS

FIG. 1 illustrates an exemplary computing architecture for a computer;

FIG. 2 illustrates a virtual focus navigation system;

FIG. 3 shows a process for navigating using virtual focus; and

FIG. 4 illustrates invoking commands while in virtual focus navigation mode, in accordance with aspects of the present invention.

### DETAILED DESCRIPTION

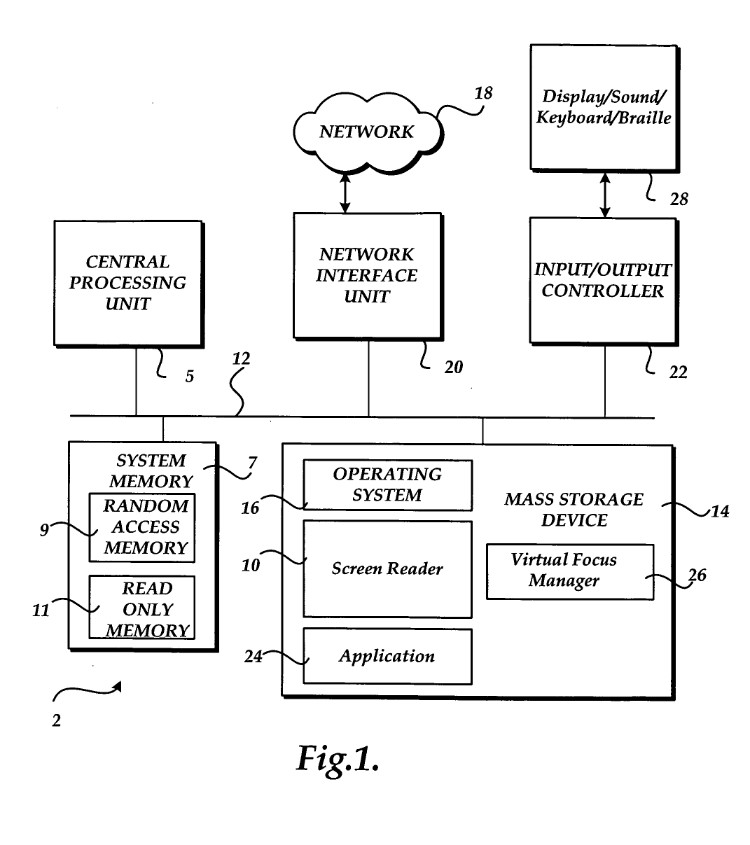

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 2 utilized in the various embodiments will be described. The computer architecture shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 also includes an input/output controller 22 for receiving and processing input from a number of devices, such as: a keyboard, mouse, Braille display, speech recognizer, electronic stylus and the like (28). Similarly, the input/output controller 22 may provide output to a display screen, a Braille display, a speech synthesizer, a printer, or some other type of device (28).

As mentioned briefly above, a number of program modules and data files may be stored in the mass storage device 14 and RAM 9 of the computer 2, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store a screen reader application program 10. The screen reader application program 10 is operative to provide functionality for reading elements on a screen, such as reading elements associated with application 24. According to one embodiment of the invention, the screen reader application program 10 comprises the Navigator screen reader application program from MICROSOFT CORPORATION. Other screen reader applications, screen magnification programs, and other programs to assist disabled users from other manufacturers may also be utilized.

The screen reader application program 10 utilizes a virtual focus manager 26 to assist in navigating a computer screen using a virtual focus navigation mode. As will be described in greater detail below, the virtual focus manager 26 provides a virtual focus navigation mode for virtually navigating within an application, such as application 24, or navigating elements on a screen. In particular, the virtual focus manager 26 performs an algorithm to navigate around a screen by adjusting a virtual focus instead of altering the current system focus. Additional details regarding the operation of the virtual focus manager 26 will be provided below.

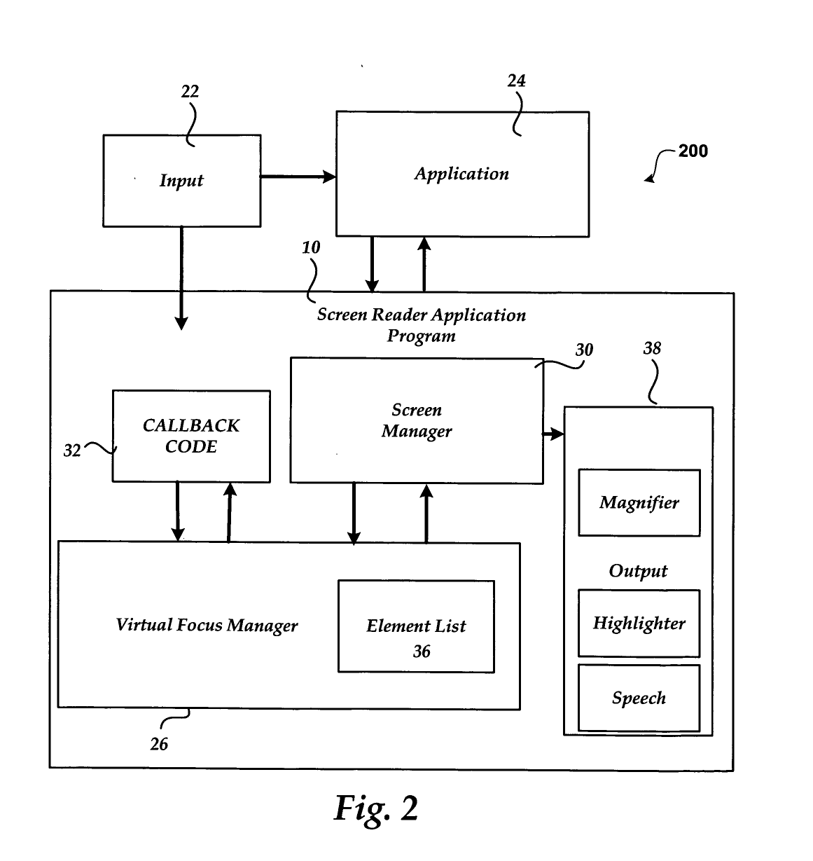

FIG. 2 illustrates a virtual focus navigation system 200, in accordance with aspects of the invention. As described briefly above, the virtual focus manager 26 provides a virtual focus navigation mode for navigating a screen or an application by adjusting a virtual focus instead of changing the system focus. Generally, virtual focus is a locus of focus that is independent of the system focus and will behave as the system focus most of the time. While in system focus mode, the virtual focus position tracks the system focus. When in virtual focus mode, the virtual focus changes as the user navigates to other Ul elements but the system focus is maintained.

Virtual Focus allows the user to navigate away from and then easily return to the position on the UI element that has the system's current input focus. The user may virtually navigate around and explore the UI elements and then either set the system's input focus to a new UI element based on the current virtual focus or simply return to the original system focus position.

According to one embodiment, virtual focus manager 26 provides a virtual focus navigation mode for screen reader application 10 such that a user may use the screen reader application 10 to navigate a screen or an application, such as application 24. According to one embodiment, virtual focus manager 26 registers for system focus change events. Any time system focus changes a notification is sent to the virtual focus manager.

Virtual focus manager 26 may be implemented within screen reader application 10 as shown in FIG. 2 or may be implemented externally from application 10 as shown in FIG. 1. In order to facilitate communication with the virtual focus manager 26, one or more callback routines, illustrated in FIG. 2 as callback code 32 may be implemented. Through the use of the callback code 32, the virtual focus manager 26 may query for additional information necessary to determine the elements on the screen and or associated with the application 24.

Screen manager 30 may communicate with the virtual focus manager 26 to determine information related to elements located on a screen. The screen manager 30 may also provide to the virtual focus manager 26 the text and other content from the screen. Screen manager 30 provides the information that is output to the user through output 38. Screen manager 30 tracks the virtual focus and announces changes in the virtual focus as the user navigates virtually from control to control. According to one embodiment, the virtual focus is a wrapper around the system focus. According to one embodiment, a focus change announcement includes the name of the new UI element and a brief description. The announcements may be made through output 38 using a speech synthesizer or some other device. A magnifier and/or highlighter can also be used to track the virtual focus and magnify or highlight the control that has virtual focus.

A user may also navigate to UI elements that cannot be navigated to with the keyboard input focus while in the virtual focus navigation mode. According to one embodiment, virtual focus manager 26 may be configured to support alternative navigation modes, such as tree navigation and spatial navigation. Tree navigation utilizes a tree of elements contained within element list 36 for navigation. For example, the element list 36 may be a hierarchical representation of the elements within the window or screen that has the current system focus that includes the various menu options along with its children. Any representation of the elements, however, may be used. For example, all of the elements may be contained within a flat list. Commands may also be used to navigate within the element list, i.e. next element, previous element, next child, previous child, and the like. Spatial navigation moves the virtual focus using a directional input, such as a mouse, stylus, keyboard and the like.

Any, or all, of the applications utilized within system 200 may be speech enabled. Speech-enabled applications are a particular benefit to users with disabilities, particularly those who cannot easily read a display screen. According to one embodiment, screen reader 10 is a speech-enabled application that may receive commands by voice input. In this embodiment, a user may change the virtual focus using a voice command.

While navigating in the virtual focus mode, the user may invoke a command on the user-interface that has the virtual focus to determine the effect of invoking the command. For example, the virtual focus may be located on a toggle button which when invoked changes the state from state A to state B. When navigating using virtual focus, the actual state of the element does not change when the command is invoked. Should the user desire to alter the state of the element that currently has the virtual focus the location of system focus may be changed to the current virtual focus position and the mode switched to system focus mode. To accomplish this, the user may invoke a command instructing virtual focus manager 26 to change the position the system's input focus to the current virtual focus. When the mode is switched back to the system focus mode any command that is invoked may alter the state.

The virtual focus manager 26 provides these facilities in response to a request from a screen reader application program 10. These input requests 22 may be from many different sources, including a keyboard, a mouse, a speech recognizer, and the like. According to one embodiment, the Insert key, Numpad 2 through Numpad are used to control the navigation of the virtual focus. According to one embodiment, the user selects a predetermined keyboard entry to enter and exit the virtual focus navigation mode. For example, the user may select the subtract key on the number pad to enter the virtual focus navigation mode.

According to one embodiment, focus changes are limited to current application, to avoid confusing scenarios where the virtual focus has moved and the system focus moves afterward. In this embodiment, if the window that currently has virtual focus disappears, the virtual focus and system focus become the same. The user, however, may use the Alt-Tab key combination, the mouse, or some other input device to change the currently active window or even to open a UI element. When this happens the Virtual Focus jumps to the new system focus position and pick up as if nothing had happened.

Virtual focus navigation can be extremely helpful in application first-use scenarios, where the user is not familiar with the user-interface elements that compose an application. An example would be a software wizard that is presented to the user for the first time. In this example, virtual focus may be used to navigate around the current page of the wizard to learn about the UI elements without the fear of losing the original position of the system focus or accidentally invoking any UI elements or changing the state of the application.

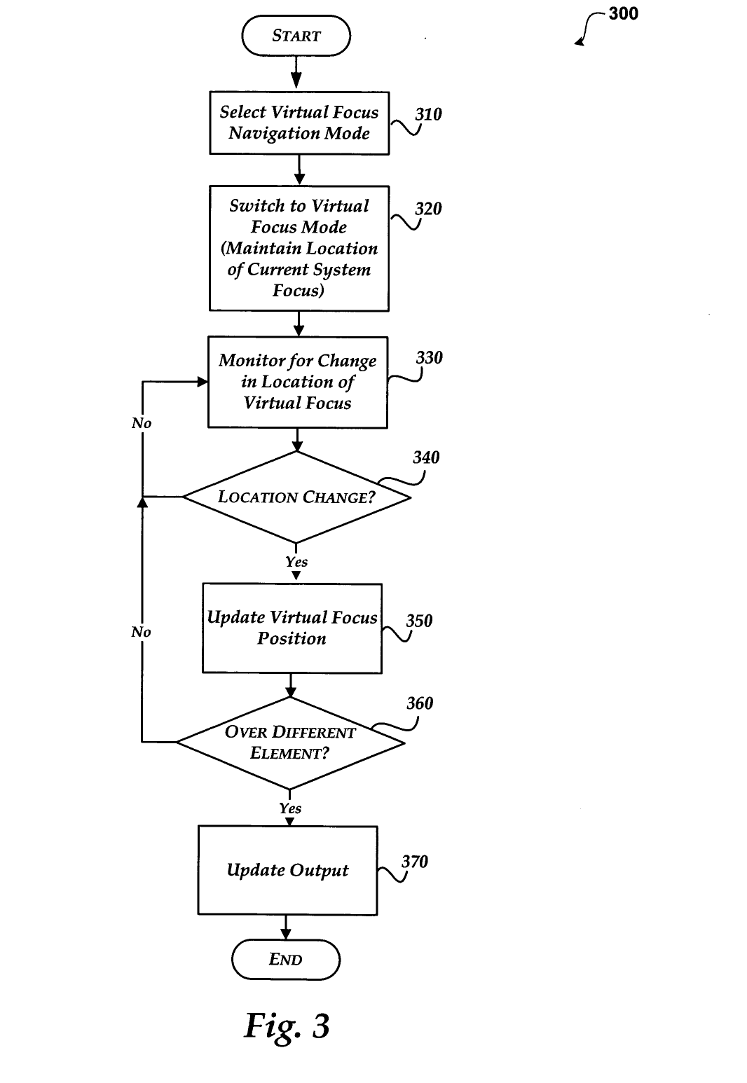

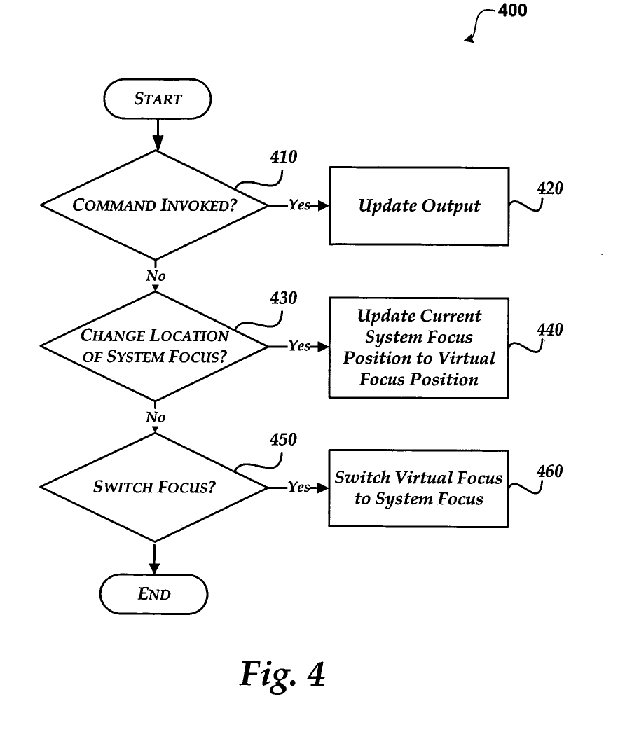

Referring now to FIGS. 3 and 4, an illustrative process for navigation using a virtual focus mode will be described. Although the embodiments described herein are presented in the context of a virtual focus manager 26 and a screen reader application program 10, other types of application programs may be utilized. For instance, the embodiments described herein may be utilized within a screen magnifier application program, an application program that provides output to a Braille device, and the like.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 3 shows a process for navigating using virtual focus. After a start operation, the process moves to operation 310, where the virtual focus navigation mode is selected. According to one embodiment, the virtual focus navigation mode is selected by entering a predefined keyboard command. Other methods may be used to enter virtual focus mode. For example, a speech command, a mouse selection, or some other input method may be used to select the virtual focus navigation mode.

Moving to operation 320, the current location of the system focus is maintained such that this system focus location may be returned to easily at any point during the virtual focus navigation.

Flowing to operation 330, the current location for the virtual focus is monitored for any change in location. According to one embodiment, a keypad is monitored to determine when a directional control is input to move the virtual focus location. For example, pressing the 2 key on the keypad could move the virtual focus position downward, while pressing the 8 key could move the virtual focus position upward. Any method of receiving a movement indication may be used. For example, a mouse or a speech engine may be utilized to receive a command to move the virtual focus.

Flowing to decision operation 340, a determination is made as to when the position of the virtual focus position changes. When there is a change in the position of the virtual focus, the process moves to operation 350 where the virtual focus position is updated. When there is not a change of location, the process returns to operation 330.

Moving to decision operation 360, a determination is made as to whether the change in the position of the virtual focus position has positioned the virtual focus over a different element. When navigating in tree mode, any change in the position will cause the focus to move to a different element since the focus changes from one element to another element based on the elements contained within the list. When the user is navigating in spatial navigation mode a change in the virtual focus position may not change the element that currently has the focus. When the position of the virtual focus changes and the focus is not on a different element, the process returns to operation 330. When the position of the virtual focus changes and the focus is on a different element, the process flows to operation 370.

Moving to operation 370 the output is updated in response to the position change of the virtual focus. The information relating to the element may be provided in many different ways. For example, the element may be highlighted, magnified, spoken to the user, provided on a Braille display, and the like.

The process then moves to an end operation and returns to processing other actions.

FIG. 4 illustrates invoking commands while in virtual focus navigation mode, in accordance with aspects of the invention.

After a start operation, the process flows to decision operation 410 where a determination is made as to whether a command is invoked. A command may be invoked on any element that currently has the virtual focus. The command may be selecting a button, entering text, opening a drop down menu, and the like. For example, the virtual focus may be positioned over a drop down menu and an open command may be invoked by the user.

When a command is invoked, the process flows to operation 420 where the output is updated. While in virtual focus mode, invoking a command on an element does not change the state of the element even though the user is provided with the result of invoking the command on the element. This allows a user to experiment with commands without having to worry about the effects of invoking an unknown command. For example, if the command invoked changes the state of a button from “on” to “off,” the program may announce “Off.” Should the user desire to actually invoke the command and change the state of the element, the user may decide to change the location of the system focus to the current location of the virtual focus.

When a command is not invoked on an element, the process flows to decision operation 430 where a determination is made as to whether to change the location of the system focus to the location of the virtual focus. When the user desires to change the location of the system focus to the virtual focus position the process flows to operation 440 where the location of the system focus is set to the current location of the virtual focus.

When the user does not desire to switch the location of the system focus to the location of the virtual focus, the process flows to decision operation 450 where a determination is made as to whether the focus should be switched back to the system focus. At any point during virtual focus navigation, a user may decide to switch focus back to the system focus. When this occurs, the virtual focus position moves to the system focus location and the virtual focus tracks the system focus until the virtual focus navigation mode is entered. According to one embodiment, the user may decide to switch the focus back to the system focus by selecting a command or changing windows on a desktop. When switching to system focus the process moves to operation 460 where the virtual focus position is changed back to the current location of the system focus. Moving to block 450 a determination is made as to whether the system focus should be set to the location of the virtual focus. For example, a user may decide that they would like to perform an operation involving the current element that is the target of the virtual focus. When the navigation mode is set to system focus any commands that are invoked may alter the state.

The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method of navigating using a virtual focus, comprising:
entering a virtual focus navigation mode;
receiving an input that directs a virtual focus location to change;
updating the virtual focus location to change in response to the input;
wherein a system focus location is maintained while in the virtual focus navigation mode;
determining an element that currently has the virtual focus; and
providing information about the element that currently has the virtual focus.

2. The method of claim 1, wherein providing the information about the element comprises performing at least one of: providing a name of the element; providing a description of the element; highlighting the element and magnifying the element.

3. The method of claim 1, wherein providing the information about the element comprises invoking a command and providing information relating to the invocation of the command; wherein invoking the command maintains a current state of the element while in the virtual focus navigation mode.

4. The method of claim 1, wherein entering the virtual focus navigation mode comprises selecting between a tree navigation mode and a spatial navigation mode.

5. The method of claim 4, wherein navigating in the tree navigation mode comprises moving from element to element in response to a received input.

6. The method of claim 4, wherein spatial navigation comprises receiving the input to direct the virtual focus location to change through at least one of: a keypad; a keyboard; and a voice input.

7. The method of claim 2, further comprising adjusting the system focus location to the virtual focus location.

8. The method of claim 2, further comprising exiting the virtual focus navigation mode and returning to a system focus mode; wherein returning to the system focus mode changes the location of the virtual focus to the location of the system focus.

9. A computer-readable medium having computer-executable instructions for navigating an application using virtual focus, comprising:
updating a virtual focus location in response to an input; wherein a system focus location is maintained while the virtual focus location changes;
determining when an element has a virtual focus in response to a comparison between the virtual focus location and a location of the element; and
providing information about the element.

10. The computer-readable medium of claim 9, wherein providing the information about the element comprises performing at least one of: providing a name of the element; providing a description of the element; highlighting the element and magnifying the element.

11. The computer-readable medium of claim 9, further comprising invoking a command on the element; providing information in response to the invocation of the command; and maintaining a state of the element before the command was invoked.

12. The computer-readable medium of claim 9, wherein entering the virtual focus navigation mode comprises entering a tree navigation mode, wherein navigating in the tree navigation mode comprises moving from element to element in response to a received input.

13. The computer-readable medium of claim 12, wherein entering the virtual focus navigation mode comprises entering a spatial navigation mode wherein navigating in the spatial navigation mode comprises receiving the input to direct the location of the virtual focus to change through at least one of: a keypad; a keyboard; and a voice input.

14. The computer-readable medium of claim 10, further comprising receiving a command to change the system focus location to the virtual focus location upon and changing the system focus location to the virtual focus location in response to the command.

15. The computer-readable medium of claim 10, further comprising exiting the virtual focus navigation mode and returning to a system focus mode upon a window change.

16. A system for navigating an application using a virtual focus navigation mode, comprising:
an application having elements;
an input component configured to receive input;
an output component configured to provide information; wherein providing the information comprises performing at least one of: providing a name of an element; providing a description of an element; highlighting an element and magnifying an element;
a virtual focus manager that is coupled to the application and the input component and that is configured to:
enter the virtual focus navigation mode;
use the input to adjust a virtual focus location while maintaining a system focus location;
determining when an element within the application receives a virtual focus; and when the element receives the virtual focus providing information about the element to the output device.

17. The system of claim 16, wherein providing the information about the element comprises invoking a command and providing information relating to the invocation of the command; wherein invoking the command maintains a current state of the element while in the virtual focus navigation mode.

18. The system of claim 16, wherein entering the virtual focus navigation mode comprises entering a tree navigation mode, wherein navigating in the tree navigation mode comprises moving from element to element in response to a received input.

19. The system of claim 16, wherein entering the virtual focus navigation mode comprises entering a spatial navigation mode wherein navigating in the spatial navigation mode comprises receiving the input to direct the location of the virtual focus to change through at least one of: a keypad; a keyboard; and a voice input.

20. The system of claim 16, further comprising changing the system focus location to the virtual focus location in response to a predetermined command.
